(19) United States
(12) Patent Application Publication
(10) Pub. No.: US 2018/0304741 A1
(43) Pub. Date: Oct. 25, 2018

(54) PROCESS FOR MANUFACTURING FILLER TUBE AND FILLER TUBE

(71) Applicant: Sumitomo Riko Company Limited, Komaki-shi (JP)

(72) Inventors: Yukinori WAKAZONO, Komaki-shi (JP); Tomoyuki FUKUYASU, Komaki-shi (JP); Fumiya MIZUNO, Komaki-shi (JP); Makoto SHIMOJO, Komaki-shi (JP); Lin JIANG, Komaki-shi (JP); Atsuo MIYAJIMA, Komaki-shi (JP)

(73) Assignee: Sumitomo Riko Company Limited, Komaki-shi (JP)

(21) Appl. No.: 16/019,747

(22) Filed: Jun. 27, 2018

Related U.S. Application Data
(63) Continuation of application No. PCT/JP2018/000141, filed on Jan. 9, 2018.

(30) Foreign Application Priority Data
Jan. 27, 2017 (JP) 2017-013636

(51) Int. Cl. B60K 15/04; B29C 47/00; B29C 47/06

(52) U.S. Cl. CPC B60K 15/04; B29C 47/0023; B29C 47/0061; B29L 2023/183; B60K 2015/0464; B60K 2015/0477; B29C 47/067

(57) ABSTRACT

A filler tube including a cylindrical body and flange is manufactured using a cylindrical workpiece. A material forms an outermost layer in the cylindrical body and flange of the cylindrical workpiece. Dividable molds move at a first speed upon adhering the cylindrical workpiece onto the site for forming the cylindrical body, thereby giving the cylindrical body a predetermined diametrical thickness; and then move at a second speed being slower than the first speed upon adhering the cylindrical workpiece onto the other site for forming the flange, thereby filling up the flange with the material and other materials for forming the flange over a diametrical range to be welded onto the fuel tank while making the diametrical thickness of the flange greater than that of the cylindrical body.

### CROSS REFERENCE TO RELATED APPLICATIONS

The present application is a Continuation Application of International Application No. PCT/JP2018/000141, filed on Jan. 9, 2018, which is incorporated herein by reference. The present invention is based on Japanese Patent Application No. 2017-013636, filed on Jan. 27, 2017, the entire contents of which are incorporated herein by reference.

### BACKGROUND OF THE INVENTION

### 1. Field of the Invention

The present invention relates to a process for manufacturing filler pipe, and a filler pipe.

### 2. Description of the Related Art

Japanese Unexamined Patent Publication (KOKAI) Gazette No. 2003-194280, and Japanese Unexamined Patent Publication (KOKAI) Gazette No. 2008-162436 disclose a filler tube to be welded onto a fuel tank, respectively. FIG. 6 of Japanese Unexamined Patent Publication (KOKAI) Gazette No. 2003-194280 illustrates that the filler tube comprises a flange in which a material making the outermost layer is welded onto the fuel tank. Moreover, Japanese Unexamined Patent Publication (KOKAI) Gazette No. 2008-162436 describes that the filler tube is welded onto the fuel tank at one of the opposite ends.

In addition, Japanese Patent Gazette No. 4779760, and Japanese Patent Gazette No. 3097990 disclose to attract a cylindrical workpiece, which is extruded through an extruder, onto the inner peripheral face of a mold in order to manufacture a tube made of resin. A plurality of suction grooves for drawing in the cylindrical workpiece are formed in the inner peripheral face of the mold. A suction force exerted via the suction grooves attracts the cylindrical workpiece onto the inner peripheral face of the mold. Moreover, Japanese Unexamined Patent Publication (KOKAI) Gazette No. 2010-260241 discloses a manufacturing process in which a plurality of dividable molds arranged annularly are moved sequentially to manufacture a resinous tube comprising a corrugated portion, and a straight portion. The manufacturing process allows the corrugated portion to have a thinner thickness, and concurrently the straight portion to have a thicker thickness by moving the molds at movement speeds differing from one another, when forming the corrugated portion, and when forming the straight portion.

### SUMMARY OF THE INVENTION

Welding the filler tube at the end face of the flange onto the fuel tank, as shown in FIG. 6 of Japanese Unexamined Patent Publication (KOKAI) Gazette No. 2003-194280, allows producing a higher joint strength than does welding the filler tube, which does not have any flange, at one of the opposite ends, as disclosed in Japanese Unexamined Patent Publication (KOKAI) Gazette No. 2008-162436, because the former can ensure a wider weld area than the latter does.

Moreover, a filler tube comprises multiple layers made of materials whose functions differ from each other. For example, a filler tube comprises a layer made of a material exhibiting fuel-permeation resistance, and an outermost layer made of another material exhibiting shock resistance, weatherability, and the like. In addition, the materials for the respective layers have different welding characteristics to a fuel tank. Consequently, forming the outermost layer of a material exhibiting favorable welding characteristics permits the filler tube, which is welded onto the fuel tank at the outermost layer as shown in FIG. 6 of Japanese Unexamined Patent Publication (KOKAI) Gazette No. 2003-194280, to produce a high joint strength.

Note herein that the joint strength of a welded face depends on a pressing force applied to the welded face upon welding a filler pipe. However, according to Japanese Unexamined Patent Publication (KOKAI) Gazette No. 2003-194280, interspaces exist between the crests in a bellows over a diametrical range corresponding to the welded face of a filler tube, because the filler tube is formed as a bellows-shaped configuration at around the welded face. Consequently, the interspaces, which exist between the crests in a bellows, make it impossible to apply a high pressing force onto the welded face upon welding the filler tube. Therefore, the interspaces cause the filler tube to exhibit a declined joint strength at the welded face.

The present invention is aimed at providing a process for manufacturing a filler tube comprising a flange, which enables a welded face to exhibit an enhanced joint strength, and such a filler tube.

### 1. Process for Manufacturing Filler Tube

A process for manufacturing filler tube directed to the present invention comprises the steps of: extruding a cylindrical workpiece comprising multiple layers by an extruder; and forming the filler tube by adhering the cylindrical workpiece onto an inner peripheral face, which a plurality of dividable molds form, while moving each of the dividable molds sequentially, thereby giving the filler tube a configuration copying the inner peripheral face.

The filler tube has an end comprising a cylindrical body, and a flange elongating outward diametrically from the cylindrical body at one of opposite ends thereof. The flange includes a first end face to be welded onto an outer face of the fuel tank, an outer peripheral face, and a second end face making a rear-face side of the first end face. The first end face, the outer peripheral face, and the second end face are formed of a material for forming an outermost layer of the cylindrical workpiece.

The step of forming the filler tube includes moving the dividable molds at a movement speed, which is set at a first speed, upon adhering the cylindrical workpiece onto a site in the dividable molds for molding the cylindrical body, thereby giving the cylindrical body a predetermined diametrical thickness. Moreover, the step of forming the filler tube further includes moving the dividable molds at another movement speed, which is set at a second speed being slower than the first speed, upon adhering the cylindrical workpiece onto another site in the dividable molds for molding the flange, thereby making a diametrical thickness of the flange greater than the predetermined diametrical thickness of the cylindrical body in conjunction with filling up the flange with the material for forming the outermost layer and other materials for forming the flange over a diametrical range thereof to be welded onto the outer face of the fuel tank.

The process for manufacturing filler tube according to the present invention constructed as described above involves forming all of the first end face, outer peripheral face and second end face of the flange of the material for forming the outermost layer of the cylindrical body. Therefore, the first end face to be welded onto a fuel tank is formed of the material for forming the outermost layer. Using a material with favorable welding characteristics as the material for forming the outermost layer allows giving an enhanced joint strength to the flange at a welded face, namely, at the first end face.

The step of forming the filler tube includes making the movement speed (i.e., the second speed) of the dividable molds, at a site of which deals with forming the flange, slower than the other movement speed (i.e., the first speed) of the dividable molds, at another site of which deals with forming the cylindrical body. The step of forming the filler tube allows making the diametrical thickness of the flange greater than the diametrical thickness of the cylindrical body. In particular, the flange is filled up with the material for forming the outermost layer of the cylindrical workpiece and other materials for forming the flange over the diametric range to be welled onto the fuel tank. Therefore, the step of forming the filler tube permits applying a high pressing force to the first end face upon pressing the flange onto the fuel tank to weld them together. As a result, the step of forming the filler tube allows giving an enhanced joint strength to the flange at a welded face, namely, at the first end face.

### 2. Filler Tube

A filler tube directed to the present invention is one to be welded onto a fuel tank, is made of thermoplastic resin, and comprises: a cylindrical body including multiple layers; and a flange including multiple layers of sorts identical with those of the cylindrical body, and elongating outward diametrically from one of opposite end sides of the cylindrical body.

The flange further includes a first end face to be welded onto an outer face of the fuel tank, an outer peripheral face, and a second end face making a rear-face side of the first end face. All of the first end face, outer peripheral face and second end face are formed by an outermost layer making the flange. The flange has a diametrical thickness being greater than another diametrical thickness which the cylindrical body has. The flange is filled up with a material for forming the outermost layer and other materials for forming the flange over a diametrical range to be welded onto the outer face of the fuel tank. The filler tube directed to the present invention allows the flange to exhibit an enhanced joint strength at a welded face, namely, at the first end face.

### BRIEF DESCRIPTION OF THE DRAWINGS

FIG. 1 is a diagram of a fuel line;

FIG. 2 is an axial cross-sectional view of a filler tube shown in FIG. 1, and illustrates the filler tube put in the linearly-shaped state;

FIG. 3 is a diagram of the filler tube according to First Embodiment, and illustrates the filler tube in an enlarged view in which it is enlarged partially at the part designated with “X” in FIG. 2;

FIG. 4 is a diagram of the filler tube according to Second Embodiment, and illustrates the filler tube in an enlarged view in which it is enlarged partially at the part designated with “X” in FIG. 2;

FIG. 5 is a diagram illustrating a manufacturing apparatus for the filler tube;

FIG. 6 is a cross-sectional diagram in which the manufacturing apparatus is cut in the direction of arrows “VI”-“VI” shown in FIG. 5 and is then turned by 90 degrees in the clockwise direction;

FIG. 7A is a front view of one of dividable molds of the manufacturing apparatus;

FIG. 7B is a diagram in which the one of the dividable molds is viewed in the direction of arrow “VIIB” shown in FIG. 7A; and

FIG. 7C is a cross-sectional diagram in which the one of the dividable molds is cut in the direction of arrows “VIIC”-“VIIC” shown in FIG. 7A.

### DESCRIPTION OF THE EMBODIMENTS

### 1. Construction of Fuel Line 1

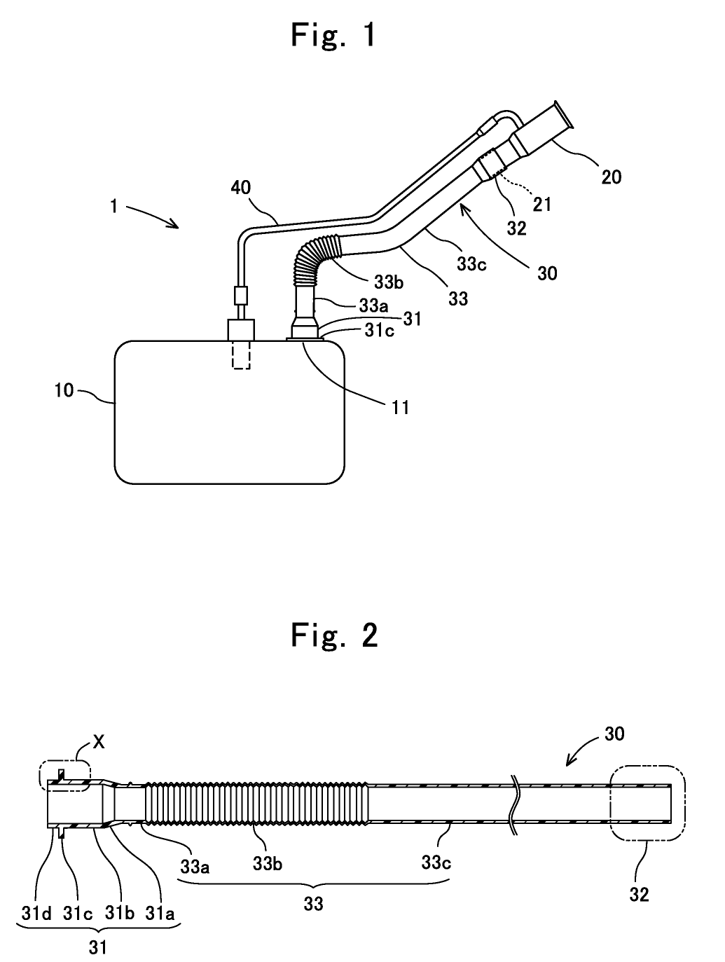

How a fuel line 1 is constructed will be hereinafter described with reference to FIG. 1. The fuel line 1 makes a line from a filler neck and up to an internal combustion engine (not shown) in an automobile. In the present embodiment, however, the fuel line 1 will be hereinafter described while focusing on the part from a filler neck 20 but up to a fuel tank 10.

The fuel line 1 comprises the fuel tank 10, the filler neck 20, a filler tube 30, and a breather line 40. The fuel tank 10, which is molded with thermoplastic resin, reserves a liquid fuel, such as gasoline, in it. The liquid fuel reserved in the fuel tank 10 is supplied to the not-shown internal combustion engine, and is used to drive it. The fuel tank 10 has a top face in which an opening 11 for supplying fuel is formed. The filler neck 20 is disposed at around an automobile outer surface through which a fuel supply nozzle (not shown) can be inserted into the filler neck 20. A not-shown filler cap is mounted in and around the filler neck 20.

The filler tube 30, which is molded with thermoplastic resin, connects between the filler neck 20 and the fuel tank 10. The filler tube 30 has an opposite end welded onto the circumferential rim around the opening 11 within the outer face of the fuel tank 10, and another opposite end fitted to and around an insertion portion 21 of the filler neck 20 by press fitting. Inserting the fuel supply nozzle into the filler neck 20, and then supplying a liquid fuel through the fuel nozzle lead to passing the liquid fuel through the filler tube 30 and then holding it in the fuel tank 10. Note herein that, when the fuel tank 10 is fully filled up with the liquid fuel, the liquid fuel, which is held in the filler tube 30 and which makes contact with the leading end of the fuel supply nozzle, stops the supply of the liquid fuel through the fuel supply nozzle automatically. Notice that the filler tube 30 is formed integrally over the entire length.

The breather line 40, which connects the fuel tank 10 with the filler neck 20, is arranged parallel to the filler tube 30. The breather line 40 makes a line for discharging fuel vapors within the fuel tank 10 to the outside of the fuel tank 10 upon supplying the liquid fuel to the fuel tank 10 by way of the filler tube 30.

### 2. Construction of Filler Tube 30

How the filler tube 30 is constructed will be hereinafter described with reference to FIG. 1. The filler tube 30 has multiple-layered structure made of thermoplastic resins of dissimilar species. As illustrated in FIG. 1, the filler tube 30 longitudinally comprises: a weld end portion 31 to be welded onto the fuel tank 10; a filler-neck end portion 32 to be mounted around the filler neck 20; and a middle portion 33 connecting the weld end portion 31 with the filler-neck end portion 32.

The weld end portion 31 is welded onto the circumferential rim around the opening 11 within the outer face of the fuel tank 10. The weld end portion 31 includes a flange 31_{c}, which elongates outward diametrically, in order to ensure a weld area. The filler-neck end portion 32, which is formed in a cylindrical shape, is fitted to and around the filler neck 20 by press fitting against the outer face of the cylindrical insertion portion 21 in the filler neck 20. That is, the filler-neck end portion 21, which has undergone the press fitting during which the insertion portion 21 of the filler neck 20 is press fitted into the filler tube 30, is enlarged diametrically, compared with the filler-neck end portion 32 prior to being subjected to the press fitting.

The middle portion 33 is designed suitably so as to make it possible to form piping routes in compliance with the relative positions or distances between the fuel tank 10 and the fuel neck 20, the layouts of peripheral devices, and so on. In the present embodiment, the middle portion 33 includes non-bellows-shaped first cylindrical site 33ₐ, a bellows-shaped site 33_{b}, and a non-bellows-shaped second cylindrical site 33_{g}. The first cylindrical site 33ₐ, which is connected to the weld end portion 31, is formed in a cylindrical shape substantially. The bellows-shaped site 33_{b}, which is connected to the first cylindrical site 33ₐ, is formed as a flexible cylindrical configuration. The second cylindrical site 33_{c} is connected to the bellows-shaped site 33_{b}, and to the filler-neck end portion 32. Moreover, the second cylindrical site 33c is formed so as to flex at the intermediate location.

Note that, in addition to the above-described middle portion 33, the filler tube 30 comprises satisfactorily an alternative middle portion 33 including a plurality of bellows-shaped parts, or comprises properly another alternative middle portion 33 formed as a bellows-shaped part entirely, or comprises adequately a still another alternative middle portion 33 free of any bellows-shaped part at any one of the locations. Moreover, although the second cylindrical site 33_{c} has a non-bellows shape and is formed so as to flex, it is formed satisfactorily in a linear shape.

### 3. Construction of Weld End Portion 31

How the weld end portion 31 of the filler tube 30 is constructed will be hereinafter described with reference to FIG. 2. FIG. 2 illustrates the filler tube 30 entirely, and shows that the filler tube 30 is put in a state where the bellows-shaped site 33_{b} and second cylindrical site 33_{c} are kept linearly. Moreover, the drawing shows that the filler-neck end portion 32 maintains a configuration prior to the press fitting to and around the insertion portion 21 of the filler neck 20, namely, it is put in a state before being deformed to enlarge diametrically.

The weld end portion 31 includes a tapered site 31ₐ, anon-bellows-shaped cylindrical body 31_{b}, a flange 31_{c}, and a non-bellows-shaped leading-end cylindrical site 31_{d}. The tapered site 31ₐ, which is connected to the first cylindrical site 33ₐ, enlarges diametrically as coming from a side of the first cylindrical site 33ₐ toward a side of the fuel tank 10. Moreover, the tapered site 31ₐ has a changing thickness, which thickens gradually, as coming from a side of the first cylindrical site 33ₐ toward a side of the fuel tank 10.

The cylindrical body 31_{b} is formed in a non-bellows cylindrical shape, for instance, in a circularly cylindrical shape especially. The cylindrical body 31_{b} is connected to a side of the fuel tank 10 in the tapered site 31ₐ. Therefore, the cylindrical body 31_{b} is formed to have a wall thickness being heavier than that of the first cylindrical site 33ₐ. The flange 31_{c} elongates outward diametrically from one of the opposite end sides of the cylindrical body 31_{b}. The flange 31_{c} has a diametrical thickness being fully greater than that of the cylindrical body 31_{b}. The flange 31_{c} is welded onto the circumferential rim around the opening 11 within the outer face of the fuel tank 10.

The leading-end cylindrical site 31_{d}, which is formed in a non-bellows cylindrical shape, for instance, in a circularly cylindrical shape especially, is disposed on a more leading side than the flange 31_{c} is disposed, namely, on an interior side of the fuel tank 10. In more detail, the leading-end cylindrical site 31_{d} elongates axially from an inner peripheral side of the flange 31_{c}. Therefore, the leading-end cylindrical site 31_{d} has an outside diameter being smaller than that of the flange 31_{c}. In the present embodiment, the leading-end cylindrical site 31_{d} is formed to have inside and outside diameters equivalent to those of the cylindrical body 31_{b}. The leading-end cylindrical site 31_{d} is located inside the opening of the fuel tank 10. The leading-end cylindrical site 31ₐ is formed to have an outside diameter being slightly smaller than the inside diameter of the opening 11 of the fuel tank 10. Consequently, the leading-end cylindrical site 31_{d} functions effectively in positioning the weld end portion 31 upon welding the flange 31_{c} onto the fuel tank 10.

### 4. Detailed Construction of Weld End Portion 31 According to First Embodiment

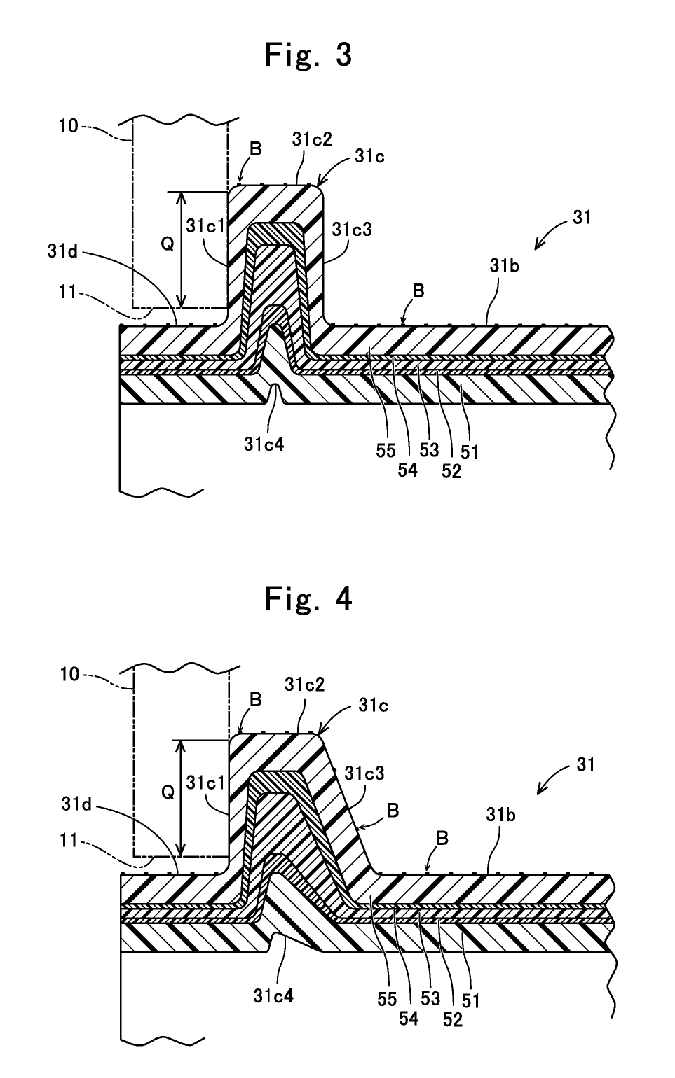

A detailed construction of the weld end portion 31 according to First Embodiment will be hereinafter described with reference to FIG. 3. The flange 31_{c} of the weld end portion 31 comprises a first end face 31_{c1}, an outer peripheral face 31_{c2}, and a second end face 31_{c3}. The first end face 31_{c1} is located on an imaginary plane intersecting perpendicularly with the axial direction of the weld end portion 31. The first end face 31_{c1} is to be welded onto the fuel tank 10 over a diametrical range “Q.” The outer peripheral face 31_{c2} is formed in the shape of a circularly cylindrical face.

The second end face 31_{c3} is located on a rear-face side of the first end face 31_{c1}. The second end face 31_{c3} is formed parallel to the first end face 31_{c1}. That is, the second end face 31_{c3} is located on another imaginary plane intersecting perpendicularly with the axial direction of the weld end portion 31. The second end face 31_{c} makes a face which is to be pressed against the fuel tank 10 with a jig (not shown) upon welding the flange 31_{c} onto the fuel tank 10. Giving the face to the second end face 31_{c3} allows securely transmitting an axial pressing force exerted by the jig against a face to be welded, namely, against the first end face 31_{c1}.

Moreover, the flange 31_{c} further comprises a minor depression groove 31_{c4} formed in the inner peripheral face. The depression groove 31_{c4} has a maximum outside diameter which is smaller than the outside diameter of the cylindrical body 31_{b}, and which is smaller than the outside diameter of the leading-end cylindrical site 31_{d}. Therefore, the flange 31_{c} is filled up with materials for forming the flange 31_{c} over the diametrical range “Q” at least to be welded onto the outer face of the fuel tank 10. That is, the flange 31_{c} does not have any interspace between the first end face 31_{c1} and the second end face 31_{c2} over the diametrical range “Q”.

Next, an internal structure of the weld end portion 31 will be hereinafter described. The filler tube 30 has the same internal structure as that of the weld end portion 31 over the entire length, although the following descriptions focus on that of the weld end portion 31 in the filler tube 30. That is, the filler tube 30 has a multi-layered structure over the entire length. The filler tube 30 comprises an innermost layer 51, an inside adhesive layer 52, an intermediate layer 53, an outside adhesive layer 54, and an outermost layer 55. In other words, the weld end portion 31 includes the tapered site 31ₐ, cylindrical body 31_{b}, flange 31_{c} and leading-end cylindrical site 31_{d} whose diametrical thicknesses differ from each other, but which have the same sort of multiple layers as those mentioned above. Moreover, proportions of the respective layers are designed to be comparative with each other virtually, independent of the locations.

The innermost layer 51, which makes a face coming in contact with the liquid fuel, is made using a material exhibiting resistance to gasoline. Moreover, when the filler-neck end portion 32 is press fitted to and around the insertion portion 21 of the filler neck 20, the innermost layer 51 is required to exert a hooking force (or come-off preventing force) to the insertion portion 21. Accordingly, the innermost layer 51 is made using a material exhibiting sealing property. Consequently, the innermost layer 51 is formed mainly of high-density polyethylene (or HDPE).

The intermediate layer 53, which is arranged on the outer peripheral side of the innermost layer 51, exhibits fuel-permeation resistance characteristics. The intermediate layer 51 is formed mainly of either an ethylene-vinyl alcohol copolymer (or EVOH) or polyamide (or PA) which exhibits fuel-permeation resistance characteristics.

The outermost layer 55, which is arranged on the outer peripheral side of the intermediate layer 53, protects the intermediate layer 53. The outermost layer 55 makes the outermost face of the filler tube 30. Accordingly, the outermost layer 55 is made using a material exhibiting shock resistance, weatherability, and chemical resistance. Consequently, the outermost layer 55 is formed mainly of either high-density polyethylene (or HDPE) or polyamide (or PA).

Note herein that the flange 31_{c} includes the first end face 31_{c1}, outer peripheral face 31_{c2} and second end face 31_{c3}, all of which are formed of the outermost layer 55. In addition, the outer peripheral face of the cylindrical body 31_{b}, and the outer peripheral face of the leading-end cylindrical site 31_{d} are formed of the outermost layer 55. The first end face 31_{c1} makes a face to be welded onto the fuel tank 10. That is, the outermost layer 55 makes a layer to be welded onto the fuel tank 10. Consequently, a material, which exhibits favorable welding characteristics to a material for forming the outer face of the fuel tank 10, is applied to form the outermost layer 55. In particular, the outermost layer 55 is formed suitably of the same sort of material as that for forming the outer face of the fuel tank 10.

The inside adhesive layer 52 bonds the outer peripheral face of the innermost layer 51 and the inner peripheral face of the intermediate layer 53 with one another. The outside adhesive layer 54 bonds the outer peripheral face of the intermediate layer 53 and the inner peripheral face of the outermost layer 55 with one another. The inside adhesive layer 52 and outside adhesive layer 54 are formed mainly of modified polyethylene (or modified PE). However, one of the innermost layer 51 and intermediate layer 53, which exhibits adhesive performance to the other one of them, makes the inside adhesive layer 52 unnecessary. Moreover, one of the intermediate layer 53 and outermost layer 55, which exhibits adhesive performance to the other one of them, makes the outside adhesive layer 54 unnecessary.

### 5. Detailed Construction of Weld End Portion 31 According to Second Embodiment

A detailed construction of the weld end portion 31 according to Second Embodiment will be hereinafter described with reference to FIG. 4. Only a part, which is distinct from those of the weld end portion 31 according to First Embodiment, will be described hereinbelow. The flange 31_{c} of the weld end portion 31 comprises a first end face 31_{c1}, an outer peripheral face 31_{c2}, and a second end face 31_{c3}. The second end face 31_{c3} includes an inclined face inclined relative to the axial direction of the weld end portion 31. In more detail, a normal line to the second end face 31_{c3} has an axial component headed for an opposite side to the fuel tank 10, and a diametrical component headed outward. That is, the flange 31_{c} has an axial width which becomes smaller as it approaches the outer peripheral side, and which becomes larger as it approaches the inner peripheral side. The inclined second end face 31_{c3} is securely suctioned or drawn in toward the inner peripheral face of later-described dividable molds (123, 124). The other constituents of the weld end portion 31 according to Second Embodiment are the same as those of the weld end portion 31 according to First Embodiment.

### 6. Manufacturing Process for Filler Tube 30

### 6-1. Outline of Manufacturing Process

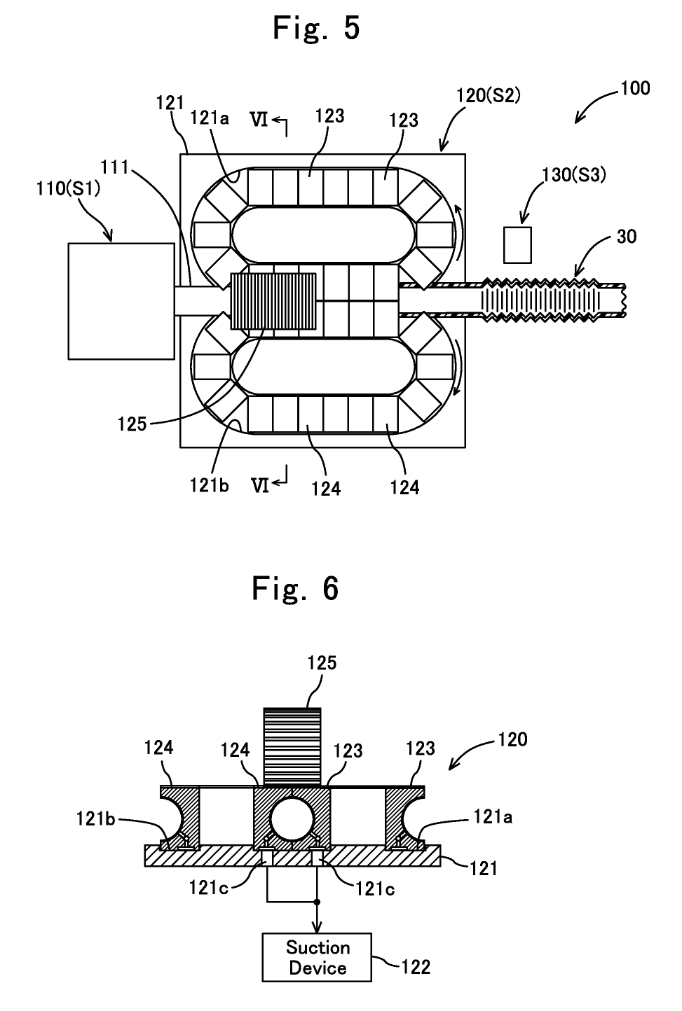

An outline of a manufacturing process for the filler tube 30 will be hereinafter described with reference to FIG. 5. As illustrated in the drawing, the filler tube 30 is manufactured via the following steps: a step “S1” of extruding a cylindrical workpiece (not shown) through an extruder 110; a step “S2” of molding the filler tube 30 by extrusion/suction molding; and a step “S3” of cutting the filler tube 30 to a predetermined length.

### 6-2. Construction of Manufacturing Apparatus 100

Next, a manufacturing apparatus 100 will be hereinafter described with reference to FIGS. 5 and 6. The manufacturing apparatus 100 comprises the extruder 110, a mold former 120, and a cutter 130. The extruder 110 extrudes a cylindrical workpiece (not shown) at a constant speed. The cylindrical workpiece, which has a multi-layered structure, is formed in a cylindrical shape having a constant inside and outside diameters. That is, the cylindrical workpiece is formed to have a constant thickness diametrically.

The mold former 120 attracts the cylindrical workpiece, which is extruded through a nozzle 111 of the extruder 110, onto the inner peripheral face of the multiple dividable molds (123, 124), thereby shaping the extruded cylindrical workpiece in a configuration copying the inner peripheral face of the multiple dividable molds (123, 124).

The mold former 120 comprises a guide stand 121, a suction device 122 shown in FIG. 6, the multiple dividable molds (123, 124), and a driving gear 125. In the top face of the guide stand 121, a first guide groove 121ₐ having an oval configuration, and a second guide groove 121_{b} disposed next to the first guide groove 121ₐ and having the same configuration as that of the first guide groove 121ₐ are formed. Moreover, in the guide stand 121, communication bores 121_{c} communicated with the first guide groove 121ₐ and second guide groove 121_{b} are formed as shown in FIG. 6. The suction device 122, which is connected with the communication bores 121_{c} in the guide stand 121 as shown in FIG. 6, suctions or draws out air in an interspace communicated with the communication bores 121_{c}.

The multiple first dividable molds 123 are molds for forming one of imaginary counterparts obtained by cutting the filler tube 30 imaginarily into two segments axially. The multiple first dividable molds 123 move sequentially on and along the first guide groove 121ₐ in the guide stand 121. That is, the multiple first dividable molds 123, each of which moves sequentially, form a half of the filler tube 30. Note herein that each of the multiple first dividable molds 123 is provided with rack teeth formed on the top face.

Moreover, the multiple second dividable molds 124 are molds for forming another one of imaginary counterparts obtained by cutting the filler tube 30 imaginarily into two segments axially. The multiple second dividable molds 124 move sequentially on and along the second guide groove 121_{b} in the guide stand 121. That is, the multiple second dividable molds 124, each of which moves sequentially, form remaining another half of the filler tube 30. Note herein that each of the multiple second dividable molds 124 is provided with rack teeth formed on the top face.

The driving gear 125 is a pinion gear moving the multiple first and second dividable molds (123, 124). The driving gear 125 is arranged at locations above some of mold pairs made by the combination of the multiple first and second dividable molds (123, 124) on a side of the extruder 110 in the manufacturing machine 100. Thus, the driving gear 125, which rotates while meshing the pinion teeth with the rack teeth of the multiple first and second dividable molds (123, 124) placed at the locations below the driving gear 125, moves the multiple first and second dividable molds (123, 124) sequentially.

Moreover, altering the rotary speed of the driving gear 125 allows altering the movement speed of the multiple dividable molds (123, 124). Increasing the movement speed of the multiple dividable molds (123, 124) makes thinner the diametrical thickness of the filler tube 30 at the sections corresponding to some of the multiple dividable molds (123, 124) which are located at around the nozzle 111 of the extruder 110. On the other hand, decreasing the movement speed of the multiple dividable molds (123, 124) makes thicker the diametrical thickness of the filler tube 30 at the sections corresponding to some of the multiple dividable molds (123, 124) which are located at around the nozzle 111 of the extruder 110.

For example, the movement speed of some of the multiple dividable molds (123, 124) corresponding to the flange 31_{c} shown in FIGS. 3 and 4 is slower than the movement speed of the other some of the multiple dividable molds (123, 124) corresponding to the cylindrical body 31_{b} shown in the drawings. Therefore, the flange 31_{c} is permitted to have a greater diametrical thickness than the diametrical thickness of the cylindrical body 31_{b}.

Note herein that a molded substance produced from out of the mold former 120 has an axially continuous configuration. That is, the continuous molded substance has a configuration in which a plurality of the filler tubes 30 are linked with each other. Hence, the cutter 130 cuts the continuous molded substance, which is shaped by the mold former 120, to a predetermined length to complete each of the individual filler tubes 30.

### 6-3. Detailed Construction of Dividable Molds (123, 124)

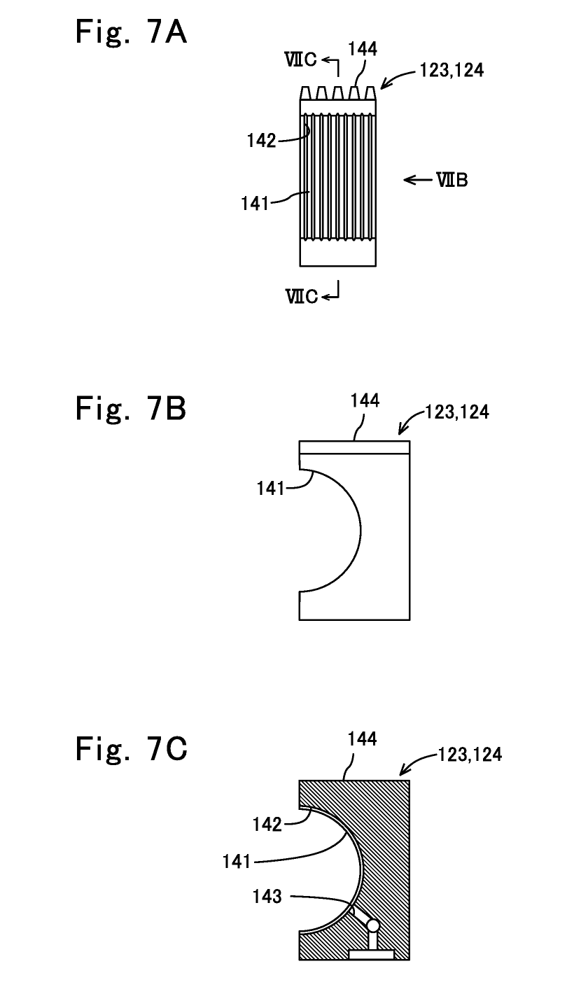

A detailed construction of the dividable molds (123, 124) will be hereinafter described with reference to FIGS. 7A through 7C. The dividable molds (123, 124) comprise a shaping face 141, a plurality of suction grooves 142, a suction bore 143, and a rack-teeth face 144. The shaping face 141, and the multiple suction grooves 142 are located on and in the inner peripheral face of the dividable molds (123, 124).

The shaping face 141 corresponds to the outer-periphery face configurations of the filler tube 30 at the filler-neck end portion 32 and middle portion 33. As illustrated in FIGS. 7B and 7C, the shaping face 141 is formed as a dented face with a semi-cylindrical shape, for instance. Moreover, the shaping face 141 is formed in an irregular or dented/protruded shape at the location corresponding to the bellows-shaped site 33_{b}. That is, the shaping face 141 molds the outer peripheral faces of the filler-neck end portion 32 and middle portion 33 in the filler tube 30.

As illustrated in FIGS. 7A and 7C, the multiple suction grooves 142 are formed in the shaping face 141 along the circumferential direction of the shaping face 141. Moreover, the multiple suction grooves 142 are formed circumferentially over the entire length of the shaping face 141. In addition, the multiple suction grooves 142, which are formed at predetermined intervals in the axial direction, are formed axially over the entire range of the dividable molds (123, 124).

As illustrated in FIG. 7C, the suction bore 143, which is communicated with each of the multiple suction grooves 142, is connected with the suction device 122 by way of the communication bores 121_{c} in the guide stand 121 as shown in FIG. 6. That is, the activated suction device 120 suctions or draws in the cylindrical workpiece toward the suction grooves 142 to attract it onto the shaping face 141. Then, minute annular projections “B” corresponding to the suction grooves 142 are formed on the outer peripheral face of the filler tube 30, as shown in FIGS. 3 and 4.

### 7. Advantageous Effects of First and Second Embodiments

As described above, the weld end portion 31 of the filler tube 30 comprises the cylindrical body 31_{b}, and the flange 31_{c}. Moreover, the flange 31_{c} includes the first end face 31_{c1} to be welled onto an outer face of the fuel tank 10, the outer peripheral face 31_{c2}, and the second end face 31_{c3}, all of which are formed of the outermost layer 55 constructing the flange 31_{c}. Therefore, forming the outermost layer 55 of a material whose welding characteristics are favorable allows giving a welded face an enhanced joint strength.

Moreover, the flange 31_{c} is formed to have a diametrical thickness being greater than that of the cylindrical body 31_{b}. In addition, the flange 31_{c} is filled up with the materials for forming the flange 31_{c} over the diametrical range “Q” to be welded onto an outer face of the fuel tank 10. Therefore, the flange 31_{c} permits an assembly worker or robot to apply a higher pressing force onto the first end face 31₁ of the flange 31_{c} upon pressing the flange 31_{c} onto the fuel tank 10 to weld them together. The result is allowing a welded face to exhibit a higher joint strength.

Note herein that the following manufacturing process is applied in order to construct the flange 31_{c} as described above. The step “S2” of molding the filler tube 30 involves setting the movement speed of the dividable molds (123, 124) at a relatively fast speed (i.e., the first speed) upon adhering the cylindrical workpiece onto the site for forming the cylindrical body 31_{b} within the dividable molds (123, 124). Thus, the setting gives the cylindrical body 31_{b} a predetermined diametrical thickness.

Meanwhile, the step “S2” of molding the filler tube 30 further involves setting the movement speed of the dividable molds (123, 124) at a relatively slow speed (i.e., the second speed) upon adhering the cylindrical workpiece onto the other site within the dividable molds (123, 124) for forming the flange 31_{c}. Thus, the other setting fills up the flange 31_{c} with the materials for forming the flange 31_{c} over the diametric range “Q” to be welded onto an outer face of the fuel tank 10 while making the diametric thickness of the flange 31_{c} greater than that of the cylindrical body 31_{b}.

In addition, the weld end portion 31 of the filler tube 30 further comprises the leading-end cylindrical site 31_{d}, which is disposed on a more leading-end side than is the flange 31_{c}, and which has a smaller outside diameter than that of the flange 31_{g}. Moreover, the leading-end cylinder site 31_{d} is located within the opening 11 of the fuel tank 10. Thus, the leading-end cylindrical site 31_{d} functions effectively in positioning the weld end portion 31 upon welding the flange 31_{c} onto the fuel tank 10. That is, the first end face 31_{c} of the flange 31_{c} is welded readily and securely onto the circumferential rim around the opening 11 in an outer face of the fuel tank 10.

Moreover, the weld end portion 31 according to Second Embodiment comprises the flange 31_{c} including the second end face 31_{c3} formed as an inclined configuration, as shown in FIG. 4. In addition, the second end face 31_{c3} is formed over a range where the dividable molds (123, 124) are provided with the suction grooves 142. Thus, the second end face 31_{c3} enables the dividable molds (123, 124) to securely suction or draw in the cylindrical workpiece onto the region where they correspond to or form the flange 31_{c}. Therefore, the second end face 31_{c3} allows molding the flange 31_{c} reliably as a desired configuration.

What is claimed is:

1. A process for manufacturing filler tube to be welded onto a fuel tank, the filler tube made of thermoplastic resin, the process comprising the steps of:
extruding a cylindrical workpiece comprising multiple layers by an extruder; and
forming the filler tube by adhering the cylindrical workpiece onto an inner peripheral face, which a plurality of dividable molds form, while moving each of the dividable molds sequentially, thereby giving the filler tube a configuration copying the inner peripheral face;
the filler tube having an end comprising a cylindrical body, and a flange elongating outward diametrically from the cylindrical body at one of opposite ends thereof;
the flange including a first end face to be welded onto an outer face of the fuel tank, an outer peripheral face, and a second end face making a rear-face side of the first end face;
the first end face, the outer peripheral face, and the second end face formed of a material for forming an outermost layer of the cylindrical workpiece;
the step of forming the filler tube including moving the dividable molds at a movement speed, which is set at a first speed, upon adhering the cylindrical workpiece onto a site in the dividable molds for molding the cylindrical body, thereby giving the cylindrical body a predetermined diametrical thickness; and
the step of forming the filler tube further including moving the dividable molds at another movement speed, which is set at a second speed being slower than the first speed, upon adhering the cylindrical workpiece onto another site in the dividable molds for molding the flange, thereby making a diametrical thickness of the flange greater than the predetermined diametrical thickness of the cylindrical body in conjunction with filling up the flange with the material for forming the outermost layer and other materials for forming the flange over a diametrical range thereof to be welded onto the outer face of the fuel tank.

2. The process for manufacturing filler tube according to claim 1, wherein:
the end of the filler tube further comprising a leading-end cylindrical portion disposed on a more leading end side thereof than is the flange, and having an outside diameter being smaller than an outside diameter of the flange;
the first end face of the flange is welded onto a circumferential rim around an opening with which the fuel tank is provided in the outer face; and
the leading-end cylindrical portion is located within the opening of the fuel tank.

3. The process for manufacturing filler tube according to claim 1, wherein:
the dividable molds comprise a suction groove for attracting the cylindrical workpiece to the inner peripheral face formed by the dividable molds; and
the second end face of the flange is formed as an inclined configuration, and is formed over a range in which the dividable molds are provided with the suction groove.

4. A filler tube to be welded onto a fuel tank, the filler tube made of thermoplastic resin, and comprising:
a cylindrical body including multiple layers; and
a flange including multiple layers of sorts identical with those of the cylindrical body, and elongating outward diametrically from one of opposite end sides of the cylindrical body;
the flange further including a first end face to be welded onto an outer face of the fuel tank, an outer peripheral face, and a second end face making a rear-face side of the first end face, the first end face, outer peripheral face and second end face formed of an outermost layer making the flange;
the flange having a diametrical thickness being greater than another diametrical thickness which the cylindrical portion has; and
the flange filled up with the material for forming the outermost layer and other materials for forming the flange over a diametrical range to be welded onto the outer face of the fuel tank.

5. The filler tube according to claim 4 further comprising a leading-end cylinder portion disposed on a more leading end side thereof than is the flange, and having an outside diameter being smaller than an outside diameter of the flange, wherein:
the first end face of the flange is welded onto a circumferential rim around an opening with which the fuel tank is provided in the outer face; and
the leading-end cylindrical portion is located within the opening of the fuel tank.
